(19) United States
(12) Patent Application Publication
(10) Pub. No.: US 2012/0178558 A1
(43) Pub. Date: Jul. 12, 2012

(54) BASEBALL OR SOFTBALL BAT WITH MODIFIED RESTITUTION CHARACTERISTICS

(75) Inventors: Michiharu Tsukamoto, Osaka-City (JP); Chui Mei Or, Osaka (JP); Yohei Yamashita, Osaka-city (JP); Toshiaki Kida, Osaka-City (JP); Kazuhiko Shindome, Hashima City (JP)

(73) Assignee: Mizuno USA, Inc., Norcross, GA (US)

(21) Appl. No.: 13/345,004

(22) Filed: Jan. 6, 2012

Related U.S. Application Data
(60) Provisional application No. 61/430,367, filed on Jan. 6, 2011.

(51) Int. Cl. A63B 59/06; B32B 37/12; B23P 11/00

(52) U.S. Cl. 473/566; 473/564; 473/567; 29/505; 156/294

(57) ABSTRACT

A softball or baseball bat with modified restitution characteristic is provided. The bat can comprise a substantially rigid core coupled with a single or multi-piece sleeve. The core can comprise a tip end, a barrel taper, a handle taper, and a handle. The sleeve can slide over the handle portion and can be pressed, molded, or adhered to the barrel taper. The resilient sleeve can be sized and shaped such that the sleeve portion is substantially the same diameter as the tip end. The sleeve can comprise a material capable of impact absorption. The sleeve can have a composite structure with inner and outer sleeve components. The sleeve can further comprise a cone to taper the sleeve in the handle taper portion of the bat. The material and thickness of the sleeve and the core can be varied to meet applicable restitution requirements.

### CROSS-REFERENCE TO RELATED APPLICATIONS AND PRIORITY CLAIM

This application claims the benefit, under 35 U.S.C. §119(e), of U.S. Provisional Patent Application No. 61/430,367, filed 6 Jan. 2011, the entire contents and substance of which is incorporated herein by reference in its entirety as if fully set forth below.

### BACKGROUND OF THE INVENTION

1. Field of the Invention

The present invention relates generally to bats for use in baseball and softball and specifically to bats with modified restitution characteristics to meet performance standards imposed by various sanctioning bodies.

2. Background of Related Art

Conventionally, bat manufacturers have endeavored to improve the performance of bats. In the case of a bat, improved performance can come in the form of, among other things, improved accuracy, reduced vibration, or increased coefficient of restitution. The latter, coefficient of restitution, relates to the power the bat imparts to the ball. In other words, the higher the coefficient of restitution of a bat, the faster the ball will rebound off the bat relative to the pitch speed.

Conventionally, bats were made out of hardwoods such as, for example, maple, birch, and ash. These woods provide good durability and reasonable cost of manufacture. In this case, however, the restitution characteristics of the bat are largely dictated (and limited) by the wood chosen. This limitation of the restitution, and thus power, of the bat, along with a certain amount of nostalgia, explains the use of wooden bats in Major League Baseball. It is thought that the extreme amount of energy major league players could impart to the ball, if armed with the more powerful aluminum or composite bats, would pose a danger to themselves, other players, and fans.

Until recently, the increased power provided by non-wooden bats was not thought to be an issue at lower levels, such as collegiate baseball and softball. As a result, aluminum and composite bats were used an unregulated in NCAA sports until approximately 1998. As a result, the materials and designs were chosen to maximize the restitution of the bat. In other words, the bats were designed to increase the velocity of the ball as it left the bat, or to be “hotter.”

As shown in FIG. 1, an example of a bat design intended to maximize restitution is shown in U.S. Pat. No. 6,872,156 to Ogawa et al. This bat 100 comprises an aluminum core 105 with tapers 110a, 110b at both ends of the barrel. The tapered portion is then wrapped with a thermal polyurethane (TPU) sheet 115 to improve the restitution properties (i.e., the power) of the bat. Unfortunately, the double taper 110a, 110b of this bat proves to be difficult using conventional aluminum manufacturing techniques (i.e., this shape cannot be swaged or extruded). In addition, the dual taper 110a, 110b requires that the TPU sleeve 115 be molded or rolled onto the bat using hot forming techniques, producing a seam 120. As a result, it is difficult to maintain the density of the material 115 during application and the seam 120 presents a possible failure point that reduces durability.

After a marked increase in hitting statistics and player injuries, however, in 1998 the NCAA began to look into regulating the bats. Initially, the bats were regulated based on the return speed of a pitch based on the swing speed of the bat. This measurement was later found to be insufficient because, unlike solid wooden bats, the balance point of hollow non-wooden bats can be manipulated to increase swing speed. The closer the balance point of the bat is to the handle, for example, the faster a player can swing the bat, which is directly related to the ball speed coming off the bat.

Since 1998, continual refinement of the NCAA standard has resulted in a rule that governs many physical aspects of bats for use in NCAA sports. The size and weight of the bat is regulated, for example, along with the moment of inertia and the Baseball Coefficient of Restitution (BBCOR). Bats must be tested in NCAA laboratories for initial certification and may be subjected to random field-testing. The latter to ensure that certain bats, such as composite bats (that tend to get “hotter” with use), remain within guidelines. Other domestic and foreign sanctioning bodies have, or are in the process of, imposing similar performance standards.

What is needed, therefore, is a bat designed, not to maximize absolute performance, but to maximize performance within a given set of guidelines. The bat should be tunable to meet different standards and inexpensive to manufacture. It is to such a bat that embodiments of the present invention are primarily directed.

### SUMMARY OF THE INVENTION

Embodiments of the present invention relate to a baseball or softball bat core with an exterior resilient sleeve. The bat core can comprise a variety of materials including, but not limited to, aluminum, fiberglass, and carbon fiber. In some embodiments, the bat core can comprise a tapered lower barrel with a step located near the tip of the bat core. The step can enable the resilient sleeve to be pressed or molded onto the bat core from the handle end and can provide a stop for the sleeve.

In some embodiments, the sleeve can comprise a one-piece sleeve of resilient material. In other embodiments, the sleeve can comprise a multi-layer sleeve. The material can be, for example and not limitation, thermal polyurethane, nylon, or fiberglass reinforced plastic. The thickness and restitution characteristics of the sleeve can be varied to meet various bat restitution protocols and/or to meet other requirements while maintaining the same bat core. In other embodiments, characteristics of the bat core can be varied to achieve the same end.

Embodiments of the present invention can comprise a batting system for baseball or softball, which can comprise a substantially rigid shell with a tip portion, a barrel portion, a handle taper, and a handle portion. In general, the barrel portion and the handle portion can be substantially cylindrical in shape, with the handle taper connecting the barrel portion and the handle portion. The system can further comprise an exterior sleeve assembly. The sleeve assembly can be disposed in an overlying manner to the barrel portion, with a first end proximate the tip portion and a second end proximate the handle taper.

In some embodiments, the exterior sleeve assembly can comprise a substantially cylindrical sleeve portion disposed proximate the barrel portion and a conical portion disposed proximate the handle taper. In some embodiments, the exterior diameter of the cylindrical sleeve portion can taper from a first end proximate the tip portion to a second end proximate the conical portion. To provide a transition between the tip of the barrel and the barrel, in some embodiments, the barrel can further comprise a barrel taper. To this end, the interior portion of the first end of the exterior sleeve assembly can be tapered to substantially the same shape as the barrel taper.

In other embodiments, the barrel portion can comprise a step, instead of a taper, disposed between the tip portion and the barrel portion. In this configuration, the first end of the exterior sleeve assembly can be substantially cylindrical (as opposed to tapered) where it abuts the step. In some embodiments, the exterior sleeve assembly can be press fit onto the barrel portion. in a preferred embodiment, the outer shell of the sleeve assembly can comprise thermoplastic polyurethane (“TPU”) and the inner shell of the sleeve assembly can comprise polyurethane (“PU”). In some embodiments, the exterior sleeve assembly can be molded onto the barrel portion. In a preferred embodiment, the substantially rigid shell can be manufactured from an aluminum alloy.

Embodiments of the present invention can also comprise a method of manufacturing a baseball or softball bat. The method can comprise, for example, forming a core comprising a tip portion, a barrel portion, a handle taper, and a handle portion, the barrel portion and the handle portion being substantially cylindrical in shape, the handle taper connecting the barrel portion and the handle portion, forming an exterior sleeve assembly, and pressing the exterior sleeve assembly over the core such that a first end of the exterior sleeve assembly is proximate the tip portion and a second end of the exterior sleeve assembly is proximate the handle taper.

In some embodiments, the exterior sleeve assembly can be press fit onto the core without using an adhesive. In other embodiments, the exterior sleeve assembly can be adhered to the core using an adhesive. In a preferred embodiment, the adhesive is a glue sheet. In some embodiments, the exterior sleeve assembly can comprise a substantially cylindrical sleeve portion disposed proximate the barrel portion and a conical portion disposed proximate the handle taper.

Additional embodiments of the present invention can comprise a method of manufacturing a baseball or softball bat with a molded sleeve. As before, the method can comprise forming a core comprising a tip portion, a barrel portion, a handle taper, and a handle portion, the barrel portion and the handle portion being substantially cylindrical in shape, the handle taper connecting the barrel portion and the handle portion. The method can further comprise forming an exterior sleeve, inserting the exterior sleeve into a sleeve mold, positioning the sleeve mold over the core such that the exterior sleeve is positioned concentrically around the barrel portion such that there is a gap therebetween, and injecting material between the exterior sleeve and the barrel portion to form an interior sleeve. In this manner, the exterior sleeve and the interior sleeve can comprise a composite sleeve assembly with a first end disposed proximate the tip portion and a second end proximate the handle taper.

In a preferred embodiment, the exterior sleeve can comprise TPU and the interior sleeve comprises PU. In this manner, when the interior sleeve is injected into the mold, it can affix or adhere the exterior sleeve to the barrel portion. In some embodiments, the method can further comprise inserting a conical portion disposed proximate the second end of the composite sleeve assembly (i.e., near the handle taper) to provide a smooth transition between the composite sleeve assembly and the handle taper. In other embodiments, the conical portion can be formed integrally with the exterior sleeve, or can be molded as part of the interior sleeve during the molding process. In a preferred embodiment, the exterior of the composite sleeve assembly is tapered from the first end to the second end.

These and other objects, features and advantages of the present invention will become more apparent upon reading the following specification in conjunction with the accompanying drawing figures.

### BRIEF DESCRIPTION OF THE FIGURES

FIG. 1 depicts a prior art hybrid bat with dual flanges.

FIG. 2a depicts a bat core with a barrel taper, in accordance with some embodiments of the present invention.

FIG. 2b depicts a bat core with a barrel step, in accordance with some embodiments of the present invention.

FIG. 3a depicts a two-piece sleeve and the tapered bat core of FIG. 2a, in accordance with some embodiments of the present invention.

FIG. 3b depicts a two-piece sleeve and the stepped bat core of FIG. 2b, in accordance with some embodiments of the present invention.

FIG. 3c depicts a one-piece sleeve and the tapered bat core of FIG. 2a, in accordance with some embodiments of the present invention.

FIG. 4 is a graph comparing coefficient of restitution with energy absorption coefficient, in accordance with some embodiments of the present invention.

FIG. 5 depicts a two-piece sleeve assembled on a bat core, in accordance with some embodiments of the present invention.

FIG. 6a is a flowchart for a method of pressing a sleeve onto a bat, in accordance with some embodiments of the present invention.

FIG. 6b is a flowchart for a method of molding a composite sleeve onto a bat, in accordance with some embodiments of the present invention.

### DETAILED DESCRIPTION OF THE INVENTION

Embodiments of the present invention relate to a baseball or softball bat, and more specifically a baseball or softball bat assembly comprising a substantially rigid core with an outer sleeve. In some embodiments, the core can comprise a substantially rigid material such as, for example, aluminum, fiberglass, or carbon fiber. The core can have a tip portion, a barrel taper, a barrel portion, and a handle taper. In some embodiments, the barrel taper can further comprise a lip or step.

The bat assembly can further comprise an exterior sleeve. The sleeve can comprise, for example, TPU, nylon, carbon fiber, or fiberglass. In some embodiments, the sleeve can be sized and shaped to be pressed, molded, or adhered to the barrel taper and barrel portion. The lip on the barrel taper can be, for example, a shoulder formed on the barrel portion to locate the sleeve. The materials, dimensions, and thicknesses, among other factors, of the sleeve and the core, can be manipulated to change the characteristics of the bat (e.g., BBCOR).

The materials described hereinafter as making up the various elements of the present invention are intended to be illustrative and not restrictive. Many suitable materials that would perform the same or a similar function as the materials described herein are intended to be embraced within the scope of the invention. Such other materials not described herein can include, but are not limited to, materials that are developed after the time of the development of the invention.

To simplify and clarify explanation, embodiments of the present invention are described below as a bat with an aluminum core or shell and a resilient, external TPU sleeve. Those skilled in the art will recognize, however, that the invention is not so limited. The shell of the bat, for example, can comprise other suitable materials such as, for example and not limitation, fiberglass, carbon fiber, or Kevlar®. Similarly, the sleeve could comprise, for example and not limitation, TPU, carbon fiber, or fiberglass.

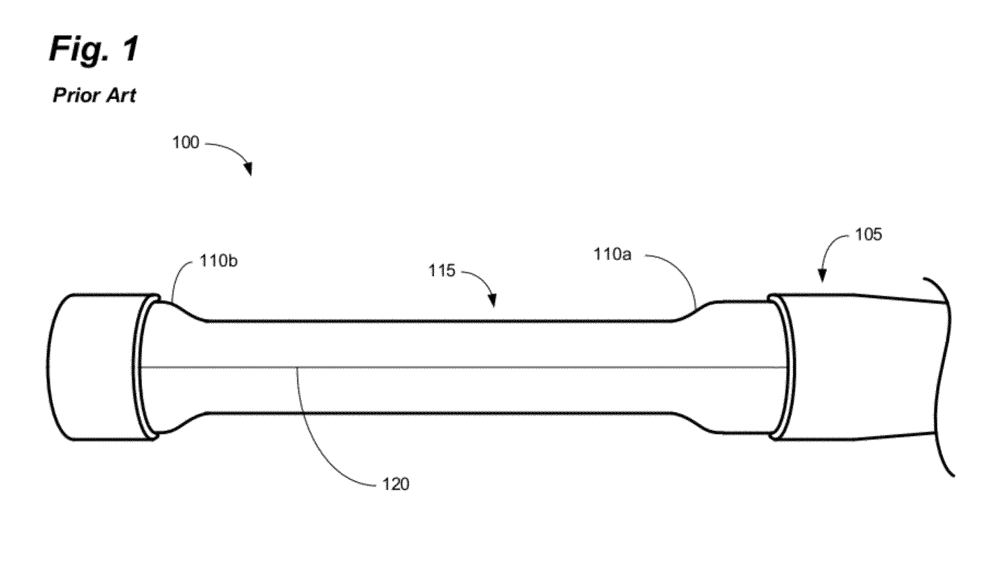

As described above, a problem with conventional hybrid bats is that they are difficult to manufacture. As shown in FIG. 1, conventional hybrid bats comprise a double barrel taper. He double barrel taper requires special forming processes and precludes the ability to use conventional metal forging and/or extruding techniques. In addition, the double taper requires that the sleeve component be seam welded or heat formed to the barrel. This is because the shape of the barrel prevents the sleeve from simply being pressed onto the barrel from one end or the other. In addition, previous bat designs have sought only to increase the power of the bat. The notion of creating ever “hotter” bats, however, is now at odds with rules imposed by a variety of sanctioning bodies.

What is needed therefore is a bat that provides superior ease of manufacture with adjustable performance characteristics. It is to such a bat that embodiments of the present invention are primarily directed.

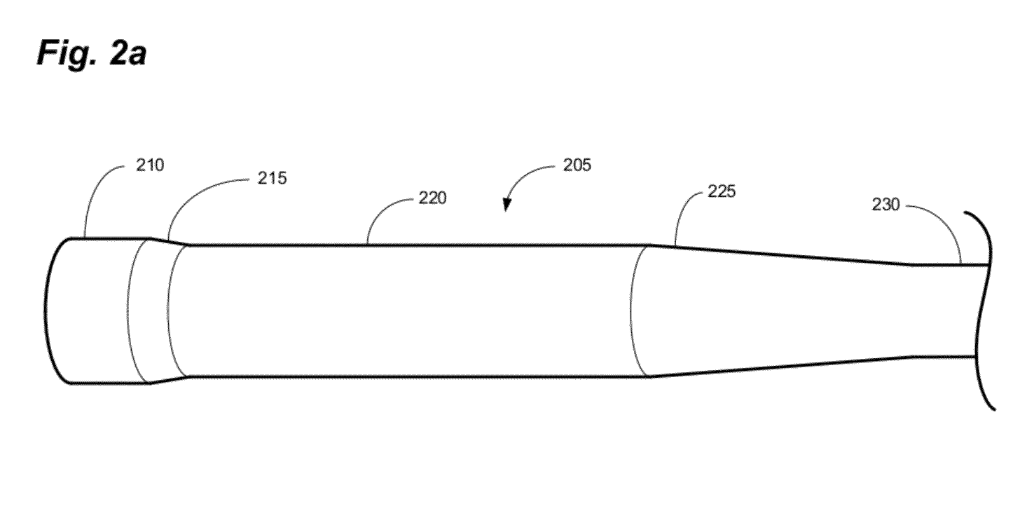

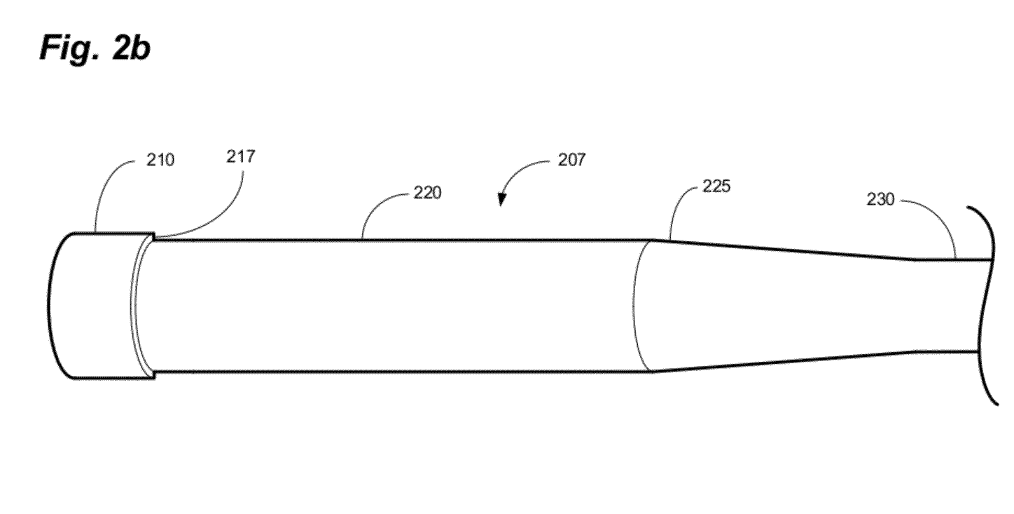

As shown in FIG. 2a, embodiments of the present invention can comprise a batting system 200 comprising a rigid core 205. In a preferred embodiment, the core 205 can comprise aluminum, but other suitable materials such as, for example and not limitation, carbon fiber, fiberglass, and metal/plastic composites are contemplated. The core 205 can be formed using many suitable methods, including but not limited to, forging, CNC machining, blow-molding, and extrusion. The core 205 can comprise a tip portion 210, a barrel taper 215, a barrel portion 220, a handle taper 225, and a handle 230. As shown, in some embodiments, the tip portion 210 can comprise the portion of the bat 200 with the largest diameter. The tip portion 210 can also comprise a shoulder, or barrel taper 215, where the tip portion 210 transitions to the barrel portion 220. The barrel taper 215 can act as a stop for the resilient sleeve, discussed below.

The core 205 can further comprise a barrel portion 220. The barrel taper 215 can transition between the larger diameter tip portion 210 and the smaller diameter barrel 220. In some embodiments, as shown in FIG. 2b, the core 207 may simply have a step 217 between the tip portion 210 and the barrel portion 220, precluding the need for the barrel taper 215. In a preferred embodiment, the barrel 220 can have substantially the same diameter from the end of the barrel taper 215, or step 217, to the beginning of the handle taper 225. The core 207 can further comprise a handle taper 225 and a handle 230. In some embodiments, the handle can comprise a knob located at the end of the handle 230 to prevent the bat from slipping out of the user's hand.

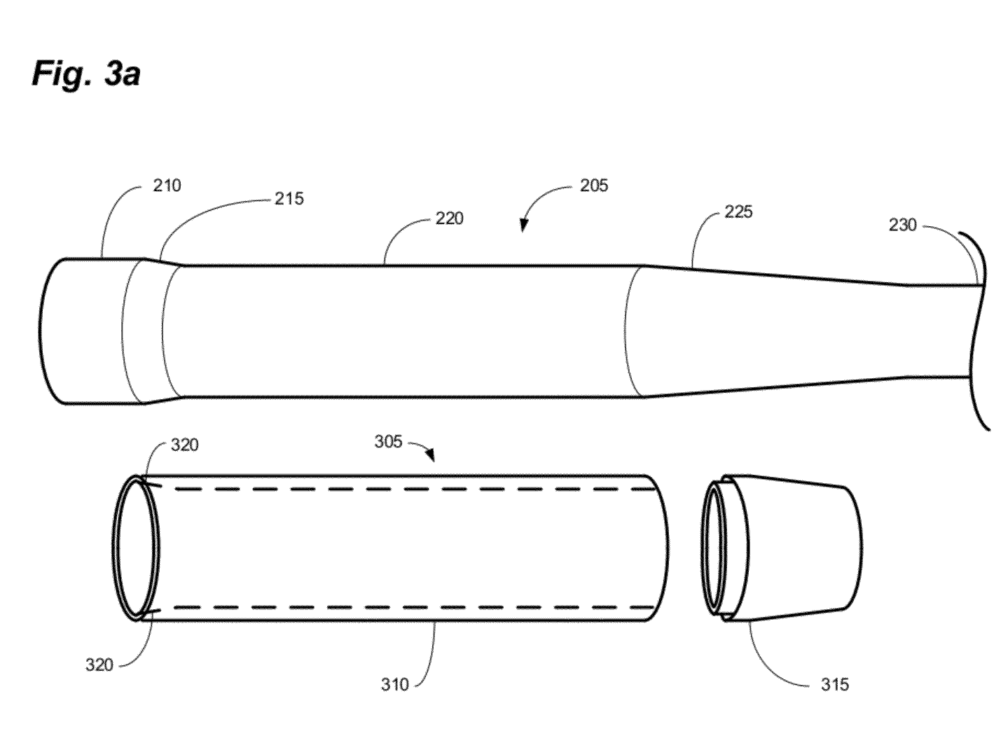

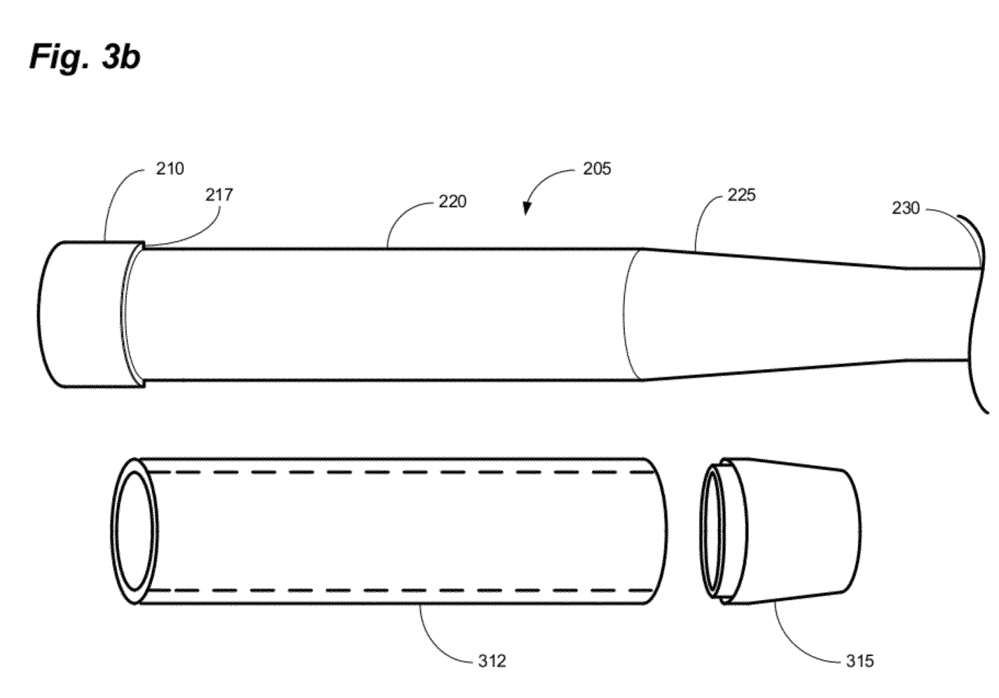

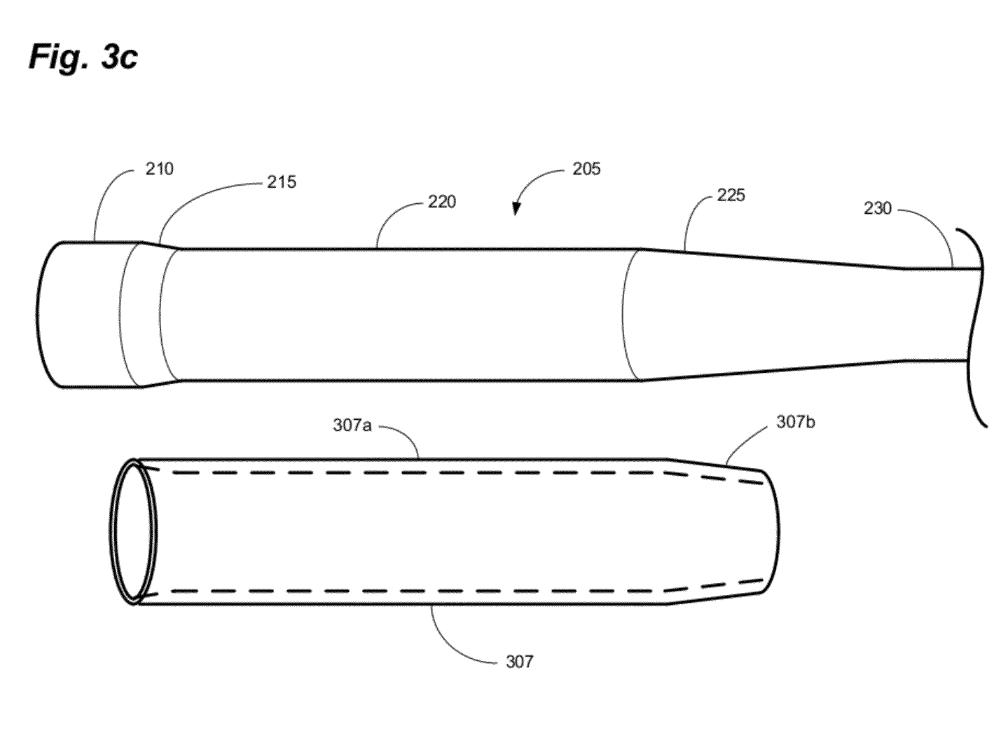

As shown in FIG. 3, the bat assembly 200 can further comprise an exterior sleeve assembly 305. In some embodiments, as shown, the sleeve assembly 305 can comprise a sleeve portion 310 and a tapered portion, or cone 315. The inside diameter of the sleeve 310 can be substantially the same as the outside diameter of the barrel 220. The outside diameter of the sleeve 310 can be tapered such that it is substantially the same diameter as the tip portion 210 on a first end, but tapers in the direction of the handle taper 225.

In some embodiments, the sleeve 310 can comprise a single or multi-layer composite material. The sleeve can comprise, for example, and not limitation, TPU, PU, carbon fiber, fiberglass, or combinations thereof. In a preferred embodiment, the sleeve comprises a TPU outer layer with a PU core. The TPU outer layer can be approximately 0.1-0.5 mm thick, while the PU inner layer can be approximately 4-10 mm thick. In a preferred embodiment, the TPU layer is approximately 0.3 mm, while the PU layer tapers from approximately 8 mm proximate the tip portion 210 to approximately 6mm proximate the handle taper 225.

Of course, other sleeve combinations could be used that included more or less layers or different components to produce different bat characteristics. The sleeve 310 could comprise, for example, one or more layers of TPU, PU, carbon fiber, or fiberglass. In some embodiments, the layers of the sleeve could also be separated by one or more separation layers (i.e., layers intended to reduce the friction between layers of the sleeve 310). The separation layer could be, for example and not limitation, polypropylene to enable the multiple layers of the sleeve 310 to deform independently.

In some embodiments, the inner diameter of the sleeve 310, shown in dashed lines, can comprise a taper 320 that substantially coincides with the barrel taper 215. In this manner, the sleeve 310 can be press fit onto the core 205. The barrel taper 215 can also act as a stop to ensure retention and proper location of the sleeve 310 on the core 205. In other embodiments, the core 205 can comprise a step 217, or shoulder, to locate a substantially cylindrical sleeve 312. See, FIG. 3b. In either configuration, an adhesive such as, for example and not limitation, epoxy or a glue sheet can also be used to secure the sleeve 310 to the barrel 220.

In some embodiments, the sleeve assembly 305 can further comprise a cone 315. The cone 315 can be tapered to substantially conform to the handle taper 225 of the bat assembly 200. In this configuration, the cone 315 can create a smooth transition from the end of the sleeve 310 to the handle portion 230, which can prevent mishifts and damage caused by hits made on the handle taper 225 or close to the handle 230 (e.g., when a pitcher “jams” the batter).

The multi-piece sleeve assembly 305 enables the sleeve 310 and cone 315 to be replaced separately. This can enable the bat to be tuned by changing, for example, the weight, shape, size, or material of the sleeve 310 and/or cone 315. This can also enable the sleeve 310 and cone 315 to be replaced independently, as necessary, for maintenance purposes (e.g., one or the other cracks during use). This can reduce maintenance costs and increase the useful life of the bat system 200.

In other embodiments, as shown in FIG. 3c, due to the shape of the core 205, the sleeve 310 and cone 315 can comprise a one-piece sleeve assembly 307, which can be installed on the barrel 220 from the handle end 230. In other words, unlike prior art bats, because both tapers 215, 225 on the core 205 reduce in the same direction (i.e., they both get smaller towards the handle), a one-piece sleeve assembly 307 with integral sleeve 307a and cone 307b can be pressed-fit or adhered to the core 205 from the handle end. This configuration can reduce manufacturing costs and increase durability, though it provides a slight reduction in tuneability and serviceability.

In some embodiments, the sleeve 310, 312 and cone 315 can be adhered or press fit to the core 205. The sleeve 310, 312 and cone 315 can comprise, for example and not limitation, nylon, fiberglass, carbon fiber, Kevlar® or combinations thereof. In some embodiments, the sleeve 310, 312 and cone 315 can comprise TPU. In a preferred embodiment, the sleeve 310, 312 and cone 315 can comprise an outer shell of TPU and an inner shell of PU.

In some embodiments, the sleeve 310, 312 can be pressed onto the core 205 from the handle 230 end until it is firmly seated against the taper 215 or shoulder 217 of the core 205. In some embodiments, the sleeve 310, 312 and/or cone 315 can be press fit onto the core 205, obviating the need for adhesives. In other embodiments, the sleeve 310, 312 and/or cone 315 can be adhered to the core 205 using, for example and not limitation, epoxy, glue sheets, or heat shrinking.

In still other embodiments, the sleeve 310 and/or cone 315 can be molded around the core 205. A mold can be placed around the barrel 220 of the core 205, for example, such that the bottom of the mold is substantially aligned with the taper 215 or shoulder 217 proximate the tip portion 210. A suitable material such as, for example and not limitation, liquid (i.e., molten) polyurethane (“PU”) can be placed into the mold. The PU can be, for example and not limitation, poured or injected into the mold (e.g., using injection molding techniques). In this configuration, the sleeve 310, 312 can be molded and adhered to the core 205 in a single process.

In yet another embodiment, a mold can be placed around the barrel 220 of the core 205, for example, such that the bottom of the mold is substantially aligned with the taper 215 or shoulder 217 proximate the tip portion 210. Prior to injection molding, a TPU sheet can be formed and placed inside the mold to form the outer layer of the sleeve. A suitable material such as, for example and not limitation, liquid (i.e., molten) polyurethane (“PU”) can then be placed into the mold between the core 205 and the TPU sheet. The PU can be, for example and not limitation, poured or injected into the mold (e.g., using injection molding techniques). This can enable a multi-layered sleeve 310, 312 to be molded and adhered to the core 205 in a single process. In this configuration, the TPU outer layer can be approximately 0.1-0.5 mm thick, while the PU inner layer can be approximately 4-10 mm thick. In a preferred embodiment, the TPU layer can be approximately 0.3 mm, while the PU layer can taper from approximately 8 mm proximate the tip portion 210 to approximately 6mm proximate the handle taper 225.

The density and/or hardness of the sleeve 310, 312 can be varied to reduce the BBCOR of the system 200 to absorb various amounts of energy to meet various regulatory standards. This can enable, for example, a single bat design to meet differing power standards by simply changing the sleeve 310, 312 and/or cone 315. In other embodiments, the thickness and/or composition of the sleeve 310, 312 can be varied to increase or decrease the amount of energy absorbed by the sleeve 310, 312. In some embodiments, the core 205, sleeve 310, 312, and cone 315 can be sold separately to enable a user to participate in multiple series offered by multiple sanctioning bodies using a single system 200. The user can, for example, buy one core 205 and then use interchangeable sleeve 310,312/cone 315 combinations to play in multiple leagues.

In some embodiments, the configuration of the core 205, sleeve 310, 312, and cone 315 can be manipulated to meet the applicable standard. Many sanctioning bodies regulate not only the BBCOR, but, for example and not limitation, the balance point of the bat assembly 200. Because the sleeve 310, 312 may comprise only a small portion of the overall mass of the bat assembly 200, it may be necessary to modify the dimensions of the core 205 to produce the necessary geometry. In some embodiments, therefore, the core 205 and/or the sleeve 310, 312 and cone 315 can be varied to produce the desired result. The configuration of the core 205, sleeve 310, 312, and cone 315 can also be varied, among other things, due to performance requirements in baseball vs. softball, women's vs. men's sports, etc.

TABLE 1
31-32 Inch Bat

| MEASUREMENT | | WALL |
|---|---|---|
| POSITION (in) | DIAMETER (in) | THICKNESS (in) |
| 1 | 2.58 | 0.102 |
| 4 | 1.98 | 0.110 |
| 6 | 1.98 | 0.110 |
| 9 | 1.98 | 0.100 |
| 11 | 1.62 | 0.092 |
| 14 | 1.14 | 0.086 |
| 16 | 0.92 | 0.090 |
| 19 | 0.88 | 0.094 |
| 21.5 | 0.88 | 0.094 |
| 24 | 0.87 | 0.094 |
| 26.5 | 0.87 | 0.094 |
| 30 | 0.87 | 0.094 |

TABLE 2
33-34 Inch Bat

| T | OUTER | |
|---|---|---|
| POSITION (in) | DIAMETER (in) | THICKNESS (in) |
| 1 | 2.58 | 0.102 |
| 5 | 1.98 | 0.110 |
| 7 | 1.98 | 0.110 |
| 10 | 1.98 | 0.100 |
| 12 | 1.62 | 0.092 |
| 15 | 1.14 | 0.086 |
| 17 | 0.92 | 0.090 |
| 20 | 0.88 | 0.094 |
| 22.5 | 0.88 | 0.094 |
| 25 | 0.87 | 0.094 |
| 27.5 | 0.87 | 0.094 |
| 30 | 0.87 | 0.094 |

As shown in Table 1 and 2, above, the dimensions of the core can vary based on, for example, the length of the bat and the intended user (e.g., men, women, or children), among other things. The amount of energy absorbed by the bat can also be varied widely based on the material used for the sleeve. The amount of energy absorbed can be measured using the coefficient of restitution (“COR”). COR, in this case, represents the speed of the ball as it leaves the bat divided by the speed of the ball as it approaches the bat without swinging the bat (i.e., its rebound speed). A COR smaller than one, for example, indicates that a portion of the kinetic energy of the ball is absorbed when it contacts the bat.

Similarly, the energy absorption coefficient (E-abs) can be calculated by dropping a weight on a test piece to obtain a stress-strain curve. In this example, a 20 mm test piece is used and is impacted with a 10 Kg weight from a height of 60 mm. The stress-strain curve can be measured using methods known in the art (e.g., strain gauges). This information can be used to calculate E-abs using equation 1, below:

$$W = {\sum }_{A = 1}^{3} {\sum }_{i = 1}^{a} 2 \frac{{μ}_{i}}{{α}_{i}} ( \text{?} - 1 ) + \frac{K}{2} ( J - \text{?} ) \\ \text{?} \text{indicates text missing or illegible when filed} \qquad ( 1 )$$

TABLE 3
Sleeve Configuration

| Name | Hardness | E-abs | COR |
|---|---|---|---|
| SK3-3(0.4) | | 75.8 | 0.492 |
| SK3-3(0.5) | | 76.6 | 0.488 |
| SK3-3(0.6) | | 77.6 | 0.494 |
| SK3-3(50/100) | | 78.9 | 0.491 |
| SK3-3(55/100) | | 79.1 | 0.483 |
| Mar. 31, 2011 | | | 0.528 |
| Adult | | | 0.470 |
| Adult(ρ) | | 76 | 0.487 |
| sk0-1 | | 58 | 0.537 |
| sk1-1 | | 56 | 0.528 |
| sk1-2 | | 80 | 0.466 |
| sk3-2 | | 71 | 0.522 |
| Feb. 15, 2011 | | | 0.528 |
| Black | 85 | 66.5 | 0.508 |
| Gray | 60 | 72.6 | 0.505 |
| Nov. 19, 2010 | — | — | 0.528 |
| [symbol] 0.45 | 60 | 48.7 | 0.577 |
| [symbol] 0.5 | 65 | 39.8 | 0.581 |
| [symbol] 0.45 | 70 | 43.4 | 0.570 |
| [symbol] 0.5 | 75 | 43.6 | 0.574 |
| [symbol] | | 72.3 | 0.503 |
| Sep. 22, 2010 | — | — | 0.528 |
| SK3-3 | 67 | 75.9 | |
| SK3-2 | 86 | 63.6 | |
| White | 49 | 62.9 | |
| Toral( [symbol] ) | 77 | 55.4 | |
| SK6-2 | 75 | 58.6 | |
| EC3662 | 79 | 49.2 | |
| Toral1 | 81 | 69.7 | |
| Toral2 | 81 | 69.2 | |

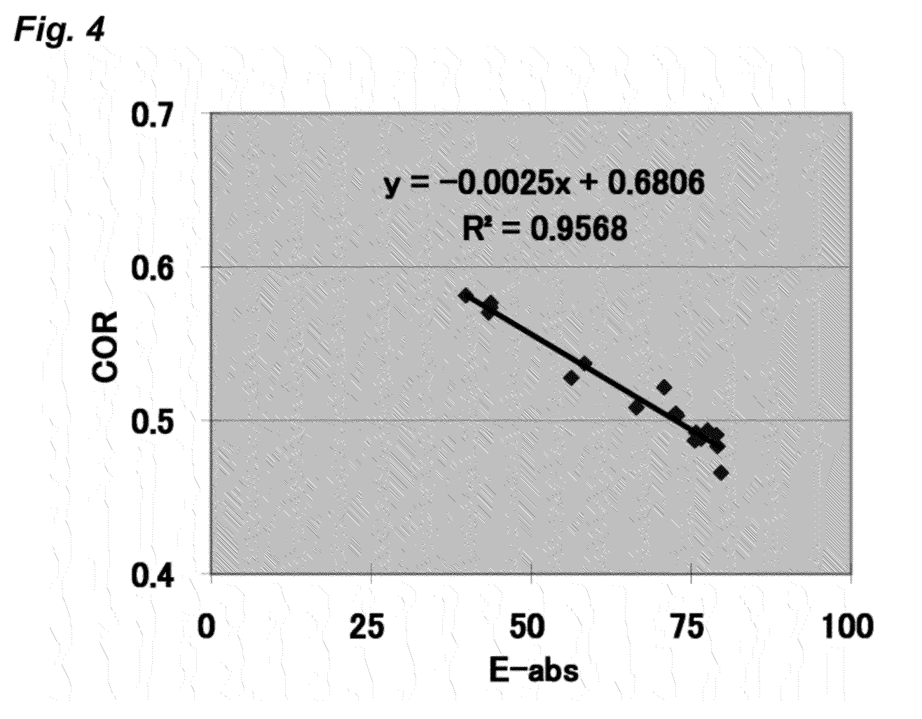

Table 3, left, shows various empirical data points based on a wide variety of sleeve and bat configurations. Using this data, FIG. 4 plots COR vs. E-abs. As expected, the COR decreases as E-abs increases. In other words, as the bat absorbs more energy, the ball rebounds at a lower speed. This tuneability enables the bat to be adjusted to meet the rules and regulations for a variety of sanctioning bodies.

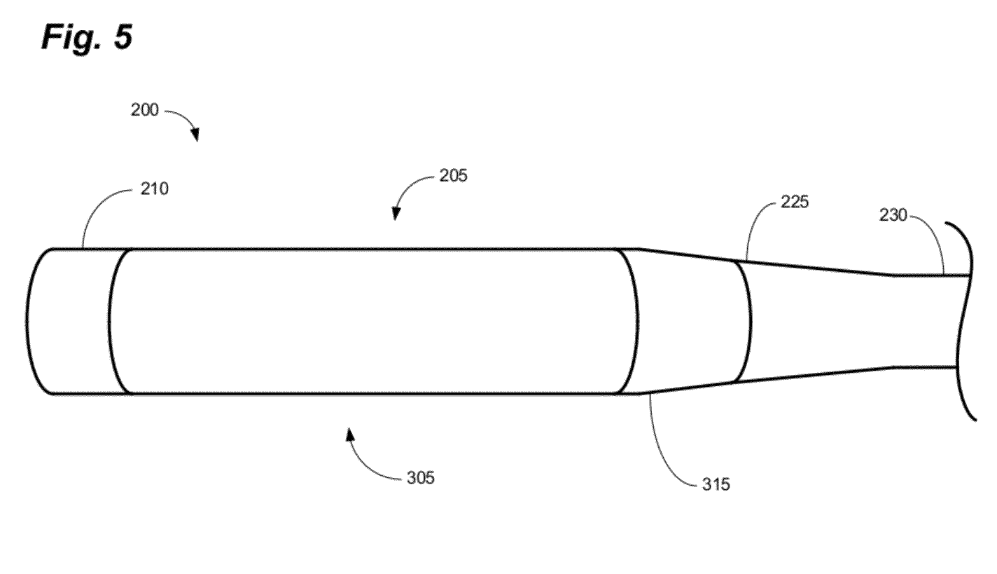

As shown in FIG. 5, the assembled bat system 200 provided a rigid core 205 partially clad in a sleeve assembly 305. The sleeve assembly 305 provides a smooth transition between the tip portion 210 of the core 205 and the handle taper 225/handle 230 of the core 205. The smooth transition enables clean hits even when the location of contact overlaps the core 205 and the sleeve assembly 305. In this configuration, the assembled system 200 offers a bat with a substantially conventional profile, while providing the tuneability necessary to meet a variety of regulations.

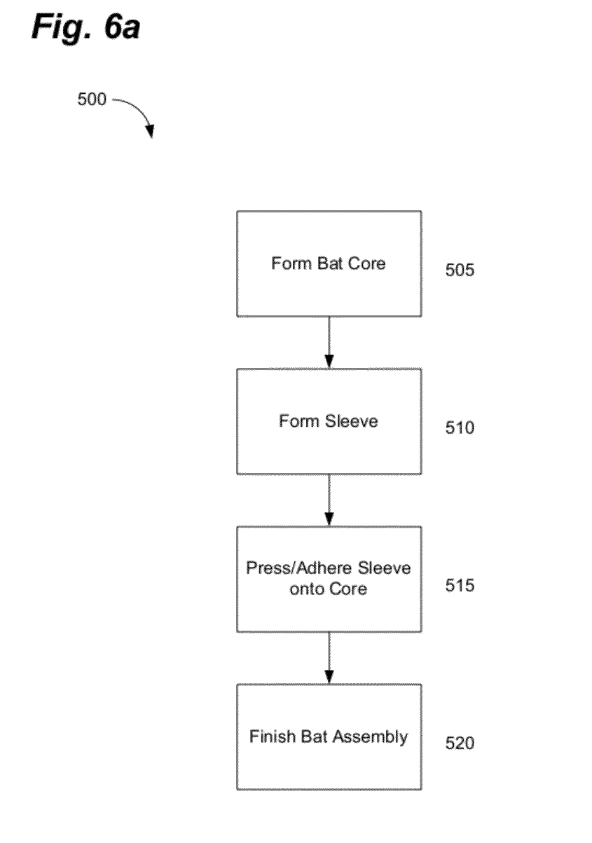

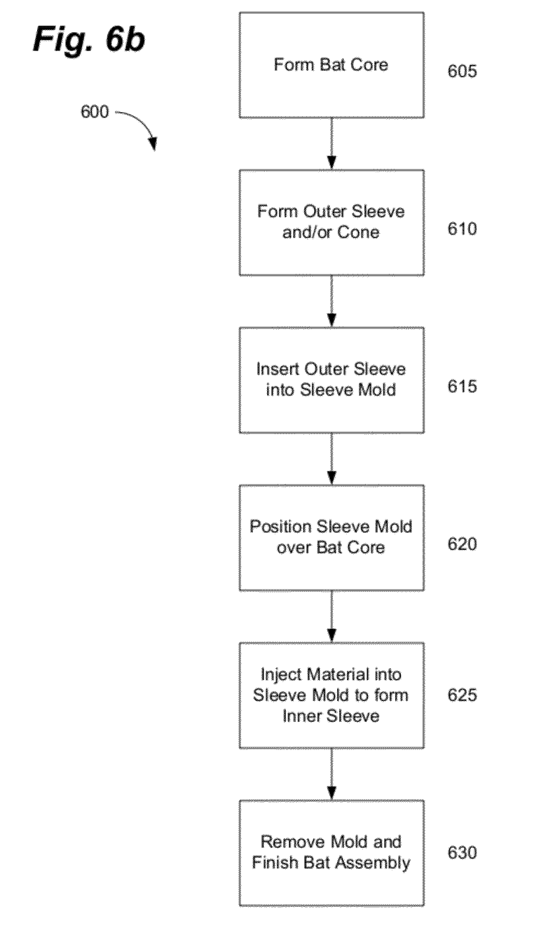

As shown in FIG. 6a, embodiments of the present invention can also comprise a method 500 for manufacturing a bat with an exterior sleeve. In some embodiments, a tube of a suitable material such as, for example and not limitation, aluminum, carbon fiber, Kevlar®, fiberglass, or combinations thereof can be molded 505 to form a bat core. In a preferred embodiment, the core can comprise aluminum and can be, for example, blow molded, forged, or swaged to form the core.

In some embodiments, the method 500 can further comprise forming 510 the sleeve assembly out of, for example and not limitation, carbon fiber, Kevlar®, or fiberglass . Depending on the material, the sleeve, and/or cone can be formed 510 using a suitable method including, but not limited to, injection molding, blow molding, or vacuum molding. In some embodiments, the sleeve assembly can comprise TPU, PU, or a combination thereof. The sleeve and cone can be injection molded 510, for example, for reduced cost with good finish quality. In other embodiments, the sleeve assembly can be molded 510 in a single part. After forming 510, the sleeve and/or cone can be press fit or adhered 515 to the core. In some embodiments, the bat assembly can be finished 520 (e.g., turned on lathe or sanded) for improved fit and finish, as well as final sizing of the bat assembly.

As shown in FIG. 6b, embodiments of the present invention can further comprise a method of manufacturing a bat 600 comprising partially molding the sleeve in place. As before, a tube of a suitable material such as, for example and not limitation, aluminum, carbon fiber, Kevlar®, fiberglass, or combinations thereof can be molded 605 to form a bat core. In a preferred embodiment, the core can again comprise aluminum and can be, for example, blow molded, forged, or swaged to form the core.

The method 600 can further comprise forming 610 the sleeve assembly out of, for example and not limitation, carbon fiber, Kevlar®, or fiberglass. Depending on the material, the sleeve, and/or cone can be formed 610 using a suitable method including, but not limited to, injection molding, blow molding, or vacuum molding. In a preferred embodiment, an outer sleeve and/or cone can be injection molded from TPU. The outer sleeve can be molded such that the inner diameter of the outer sleeve is larger than the outer diameter of the bat barrel. The outer sleeve can then be placed into a sleeve mold 615 that is substantially the same shape as the outer sleeve.

The sleeve mold can then be positioned over the core 620 such that the outer sleeve is concentrically located about the core and such that a first end of the outer sleeve is aligned with the barrel taper (or step). In this manner, the outer sleeve is properly located on and about the bat, but a concentric space exists between the outer sleeve and the barrel. Material can then be injection molded 625 into the space between the outer sleeve and the core. This provides an inner sleeve and affixes the outer sleeve to the barrel. In a preferred embodiment, the inner sleeve can comprise PU. The sleeve mold can then be removed 630 and final finishing can be performed (e.g., to remove extra material, smooth edges, etc.)

While several possible embodiments are disclosed above, embodiments of the present invention are not so limited. For instance, while several possible configurations have been disclosed (e.g., an aluminum bat with a TPU sleeve), other suitable materials and configurations could be selected without departing from the spirit of embodiments of the invention. In addition, the location and configuration used for various features of embodiments of the present invention can be varied according to a particular bat size and weight, a particular set of rules, or simply user preference. Such changes are intended to be embraced within the scope of the invention.

The specific configurations, choice of materials, and the size and shape of various elements can be varied according to particular design specifications or constraints requiring a device, system, or method constructed according to the principles of the invention. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced therein.

1. A batting system for baseball or softball, the batting system comprising:
a substantially rigid shell comprising:
a tip portion, a barrel portion, a handle taper, and a handle portion, the barrel portion and the handle portion being substantially cylindrical in shape, the handle taper connecting the barrel portion and the handle portion; and
an exterior sleeve assembly, disposed in an overlying manner to the barrel portion, with a first end proximate the tip portion and a second end proximate the handle taper.

2. The batting system of claim 1, wherein the exterior sleeve assembly comprises a substantially cylindrical sleeve portion disposed proximate the barrel portion and a conical portion disposed proximate the handle taper.

3. The batting system of claim 2, wherein an exterior diameter of the cylindrical sleeve portion tapers from a first end proximate the tip portion to a second end proximate the conical portion.

4. The batting system of claim 1, the substantially rigid shell further comprising a barrel taper disposed between the tip portion and the barrel portion to provide a transition therebetween.

5. The batting system of claim 4, wherein an interior portion of the first end of the exterior sleeve assembly is tapered to substantially conform to the barrel taper.

6. The batting system of claim 1, further comprising a step disposed between the tip portion and the barrel portion;
wherein the first end of the exterior sleeve assembly is substantially cylindrical and abuts the step.

7. The batting system of claim 1, wherein the exterior sleeve assembly is press fit onto the barrel portion.

8. The batting system of claim 1, wherein the exterior sleeve assembly comprises:
an outer shell comprising thermoplastic polyurethane (“TPU”); and
an inner shell comprising polyurethane (“PU”).

9. The batting system of claim 8, wherein the exterior sleeve assembly is molded onto the barrel portion.

10. The batting system of claim 1, wherein the substantially rigid shell comprises an aluminum alloy.

11. A method of manufacturing a baseball or softball bat comprising:
forming a core comprising a tip portion, a barrel portion, a handle taper, and a handle portion, the barrel portion and the handle portion being substantially cylindrical in shape, the handle taper connecting the barrel portion and the handle portion;
forming an exterior sleeve assembly; and
pressing the exterior sleeve assembly over the core such that a first end of the exterior sleeve assembly is proximate the tip portion and a second end of the exterior sleeve assembly is proximate the handle taper.

12. The method of manufacture of claim 11, wherein the exterior sleeve assembly is press fit onto the core without using an adhesive.

13. The method of manufacture of claim 11, wherein the exterior sleeve assembly is adhered to the core using an adhesive.

14. The method of manufacture of claim 13, wherein the adhesive is a glue sheet.

15. The method of manufacture of claim 11, wherein the exterior sleeve assembly comprises a substantially cylindrical sleeve portion disposed proximate the barrel portion; and
a conical portion disposed proximate the handle taper.

16. A method of manufacturing a baseball or softball bat comprising:
forming a core comprising a tip portion, a barrel portion, a handle taper, and a handle portion, the barrel portion and the handle portion being substantially cylindrical in shape, the handle taper connecting the barrel portion and the handle portion;
forming an exterior sleeve;
inserting the exterior sleeve into a sleeve mold;
positioning the sleeve mold over the core such that the exterior sleeve is positioned concentrically around the barrel portion such that there is a gap therebetween; and
injecting material between the exterior sleeve and the barrel portion to form an interior sleeve;
wherein the exterior sleeve and the interior sleeve comprise a composite sleeve assembly with a first end disposed proximate the tip portion and a second end proximate the handle taper.

17. The method of claim 16, wherein the exterior sleeve comprises TPU; and
the interior sleeve comprises PU; and
wherein the interior sleeve adheres the exterior sleeve to the barrel portion.

18. The method of claim 16, further comprising:
inserting a conical portion disposed proximate the second end of the composite sleeve assembly to provide a smooth transition between the composite sleeve assembly and the handle taper.

19. The method of claim 16, further comprising:
wherein the composite sleeve assembly further comprises a conical portion integrally molded into the second end of the composite sleeve assembly to provide a smooth transition between the composite sleeve assembly and the handle taper.

20. The method of claim 16, wherein the exterior of the composite sleeve assembly is tapered from the first end to the second end.
